(19) United States
(12) Patent Application Publication
(10) Pub. No.: US 2026/0252706 A1
(43) Pub. Date: Aug. 27, 2026

(54) AUTOMATED LARGE LANGUAGE MODEL RED-TEAMING

(71) Applicant: International Business Machines Corporation, Armonk, NY (US)

(72) Inventors: Muhammad Zaid HAMEED, Dublin (IE); Stefan SCHOEPF, Cambridge (GB); Ambrish RAWAT, Dublin (IE); Kieran FRASER, Raheny (IE); Giulio ZIZZO, Dublin (IE); Giandomenico CORNACCHIA, Dublin (IE); Mark PURCELL, Naas (IE)

(21) Appl. No.: 19/064,017

(22) Filed: Feb. 26, 2025

(51) Int. Cl. G06F 21/57; G06F 16/28

(52) U.S. Cl. CPC G06F 21/577; G06F 16/285; G06F 2221/034

(57) ABSTRACT

In some implementations, a device may cluster a set of jailbreak attack templates to form an attack style library according to attack styles. The device may select a subset of clusters based on a red-teaming goal to create a combination of different attack styles. The device may generate diverse seed prompts based on the selected subset of clusters. The device may apply a branching phase to each seed prompt to generate a plurality of prompt samples. The device may apply a similarity filter algorithm to remove redundant prompt samples from the prompt samples. The device may evaluate remaining prompt samples to determine successful prompt samples that meet a jailbreak success threshold. The device may output the successful prompt samples.

### BACKGROUND

This disclosure relates to large language models (LLMs), and more specifically, to red-teaming.

### SUMMARY

Some aspects described herein relate to a computer-implemented method. The computer-implemented method may include clustering, by a processor set, a set of jailbreak attack templates to form an attack style library according to attack styles, where the set of jailbreak attack templates are associated with bypassing measures that are to prevent non-aligned outputs of large language models (LLMs). The computer-implemented method may include selecting, by the processor set, a subset of clusters based on a red-teaming goal to create a combination of different attack styles. The computer-implemented method may include generating, by the processor set, a plurality of diverse seed prompts based on the selected subset of clusters. The computer-implemented method may include applying, by the processor set, a branching phase to each seed prompt of the plurality of diverse seed prompts to generate a plurality of prompt samples. The computer-implemented method may include applying, by the processor set, a similarity filter algorithm to remove redundant prompt samples from the plurality of prompt samples. The computer-implemented method may include evaluating, by the processor set, remaining prompt samples of the plurality of prompt samples to determine one or more successful prompt samples that meet a jailbreak success threshold. The computer-implemented method may include merging, by the processor set, the one or more successful prompt samples based on increasing attack diversity and increasing attack strength to obtain one or more merged prompt samples. The computer-implemented method may include outputting the one or more successful prompt samples.

Some aspects described herein relate to a computer system. The computer system may include a processor set, one or more computer-readable storage media, and program instructions stored on the one or more computer-readable storage media to cause the processor set to perform operations. The operations may include receiving a set of jailbreak attack templates associated with LLM jailbreaking that are clustered into a plurality of clusters according to attack styles. The operations may include providing the set of jailbreak attack templates to a combination LLM that combines attack styles of the plurality of clusters based on a red-teaming goal. The operations may include receiving, from the combination LLM, one or more attack style combinations of jailbreak attack templates. The operations may include generating a diverse set of seed prompts based on the one or more attack style combinations. The operations may include generating a plurality of prompt samples from each seed prompt of the diverse set of seed prompts. The operations may include selecting a plurality of jailbreak prompt samples from the plurality of prompt samples for each seed prompt based on a jailbreak success score for each prompt sample.

Some aspects described herein relate to a computer program product. The computer program product may include one or more computer-readable storage media and program instructions stored on the one or more computer-readable storage media to perform operations. The operations may include selecting a subset of clusters from an attack style library based on a red-teaming goal associated with bypassing measures that are to prevent non-aligned outputs of LLMs. The operations may include generating, using a strategy diversification LLM, a diverse set of seed prompts by combining attack styles from the selected subset of clusters. The operations may include branching each seed prompt of the diverse set of seed prompts into a plurality of prompt samples using a branching LLM. The operations may include applying a similarity filter to remove redundant prompt samples. The operations may include merging remaining prompt samples to create a diverse set of jailbreak prompt samples that are diverse with respect to attack style. The operations may include evaluating the diverse set of jailbreak prompt samples against a target LLM to determine jailbreak success potential. The operations may include outputting a set of selected jailbreak prompt samples that are selected based on the evaluating.

### BRIEF DESCRIPTION OF THE DRAWINGS

FIG. 1 is a diagram of an example computing environment for automated red-teaming described herein.

FIGS. 2A-2D show a diagram of an architecture for an attack diversification system that is designed to meet a red-teaming goal.

FIG. 3 is a flowchart of an example process associated with LLM red-teaming.

FIG. 4 is a flowchart of an example process associated with LLM red-teaming.

FIG. 5 is a flowchart of an example process associated with LLM red-teaming.

### DETAILED DESCRIPTION

The following detailed description of example implementations refers to the accompanying drawings. The same reference numbers in different drawings may identify the same or similar elements.

Large Language Models (LLMs) are increasingly used in various applications, bringing new opportunities but also new security risks, including jailbreak attacks. Jailbreaking refers to the process of manipulating or bypassing the security measures of a computer system, language model, or other machine learning model to gain unauthorized access or to cause the system to produce unintended or undesired results. In the context of language models, jailbreaking involves crafting specific inputs or prompts that are designed to manipulate the model's behavior, such as causing it to produce biased or toxic responses.

Red-teaming refers to the practice of simulating an attack on a computer system, language model, or other machine learning model in order to test its defenses and identify potential vulnerabilities. Red-teaming involves simulating the actions and techniques of an attacker in a controlled environment to evaluate the effectiveness of the system's security measures and to identify areas where the system may be susceptible to attack. The goal of red-teaming is to identify potential security weaknesses and to develop mitigation strategies to prevent or mitigate potential attacks. In the context of language models, red-teaming typically involves generating and testing a wide range of inputs and prompts to evaluate the model's robustness and resilience to adversarial attacks.

Continuous Red Teaming (CRT) checks are required to evaluate the robustness of LLMs against these attacks. However, existing CRT checks are expensive, requiring constant updating of jailbreaking strategies and iterative runs through a vast number of goals. These methods often fail to incorporate newly discovered attack styles and may not be adaptable to specific model versions. Current approaches to mitigate these issues, such as using known attack libraries or static collections of jailbreak prompts, are limited in their ability to consider adaptations of these attacks to specific model versions and combinations of attack styles.

Some implementations described herein provide a computer system and method for scalable automated LLM red teaming, which evaluates the robustness of LLMs against jailbreak attacks in a resource and query efficient manner, by generating diverse multi-style jailbreak samples. For example, the computer system (implementing the method) may cluster a set of jailbreak attack templates according to attack styles, select a subset of clusters based on a red-teaming goal, and combine jailbreak attack templates into a combination of attack styles, where each cluster of the combination includes jailbreak attack templates of different attack styles. The computer system may generate a diverse set of seed prompts based on the selected subset of clusters, and then apply a branching phase to each seed prompt to generate a plurality of prompt samples. The computer system may apply a similarity filter algorithm to remove redundant prompt samples, and evaluate remaining prompt samples (e.g., assigning a score) to determine one or more successful prompt samples that meet a jailbreak success threshold. These successful prompt samples may be output for analysis. In some implementations, the computer system may merge the one or more successful prompt samples based on increasing attack diversity and strength to obtain one or more merged prompt samples that are provided to a next iteration of the evaluating.

In this way, the computer system and method provides a solution to reduce computational complexity associated with existing CRT checks. The modular approach enables efficient integration of newly discovered attacks through attack style clustering, goal matching, and similarity filtering. By generating diverse multi-style jailbreak samples in a resource and query efficient manner, the computer system and method conserve computing resources, networking resources, and/or other resources that would have otherwise been consumed by processing redundant or irrelevant prompt samples. Additionally, the computer system and method may reduce memory requirements by storing fewer, more effective jailbreak samples. As a result, the computer system and method may conserve processing resources, memory resources, network resources, and/or the like. The increased diversity improves the defenses of LLMs, which conserves processing resources that would otherwise be wasted by handling breaches.

According to an aspect, there is provided a computer-implemented method that includes clustering, by a processor set, a set of jailbreak attack templates to form an attack style library according to attack styles, where the set of jailbreak attack templates are associated with bypassing measures that are to prevent non-aligned outputs of LLMs. The computer-implemented method includes selecting, by the processor set, a subset of clusters based on a red-teaming goal to create a combination of different attack styles. The computer-implemented method includes generating, by the processor set, a plurality of diverse seed prompts based on the selected subset of clusters. The computer-implemented method includes applying, by the processor set, a branching phase to each seed prompt of the plurality of diverse seed prompts to generate a plurality of prompt samples. The computer-implemented method includes applying, by the processor set, a similarity filter algorithm to remove redundant prompt samples from the plurality of prompt samples. The computer-implemented method includes evaluating, by the processor set, remaining prompt samples of the plurality of prompt samples to determine one or more successful prompt samples that meet a jailbreak success threshold. The computer-implemented method includes outputting, by the processor set, the one or more successful prompt samples.

By generating diverse multi-style jailbreak samples in a resource and query efficient manner, the method conserves computing resources, networking resources, and/or other resources that would have otherwise been consumed by processing redundant or irrelevant prompt samples. Additionally, the method may reduce memory requirements by storing fewer, more effective jailbreak samples. In this way, the method may conserve processing resources, memory resources, network resources, and/or the like.

In one or more embodiments, applying a pruning phase to remove prompt samples from the plurality of prompt samples that are not relevant to achieving the red-teaming goal. In this way, the system conserves computing resources, networking resources, and/or other resources that would have otherwise been consumed by processing redundant or irrelevant prompt samples.

In one or more embodiments, the method further comprises merging the one or more successful prompt samples based on increasing attack diversity and increasing attack strength to obtain one or more merged prompt samples; and providing the one or more merged prompt samples to a next iteration of the evaluating. In this way, the increased diversity improves the defenses of LLMs, which conserves processing resources that would otherwise be wasted by handling breaches.

In one or more embodiments, the clustering of the set of jailbreak attack templates comprises clustering the set of jailbreak attack templates using a clustering LLM.

In one or more embodiments, the evaluating of the remaining prompt samples comprises evaluating the remaining prompt samples using an evaluation LLM.

In one or more embodiments, the attack style library is a modular library. In this way, the system is easily scalable, which conserves processing resources and time.

In one or more embodiments, the generating of the plurality of diverse seed prompts comprises generating the plurality of diverse seed prompts using a seed prompt LLM.

In one or more embodiments, the combination of different attack styles includes an attack based on persuasion, an attack based on encoded data, an attack based on a logical fallacy, or a combination thereof.

In one or more embodiments, the merging comprises combining prompt samples from different branches.

According to an aspect, a computer system includes a processor set, one or more computer-readable storage media, and program instructions stored on the one or more computer-readable storage media to cause the processor set to perform operations. The operations comprise receiving a set of jailbreak attack templates associated with LLM jailbreaking that are clustered into a plurality of clusters according to attack styles. The operations comprise providing the set of jailbreak attack templates to a combination LLM that combines jailbreak attack templates based on a red-teaming goal. The operations comprise receiving, from the combination LLM, one or more attack style combinations of jailbreak attack templates. The operations comprise generating a diverse set of seed prompts based on the one or more attack style combinations. The operations comprise generating a plurality of prompt samples from each seed prompt of the diverse set of seed prompts. The operations comprise selecting a plurality of jailbreak prompt samples from the plurality of prompt samples for each seed prompt based on a jailbreak success score for each prompt sample.

By generating diverse multi-style jailbreak samples in a resource and query efficient manner, the system conserves computing resources, networking resources, and/or other resources that would have otherwise been consumed by processing redundant or irrelevant prompt samples. Additionally, the system may reduce memory requirements by storing fewer, more effective jailbreak samples. In this way, the system may conserve processing resources, memory resources, network resources, and/or the like. The increased diversity improves the defenses of LLMs, which conserves processing resources that would otherwise be wasted by handling breaches.

In one or more embodiments, the operations comprise outputting the plurality of jailbreak prompt samples.

In one or more embodiments, the operations comprise applying a branching phase to multiply the plurality of prompt samples. In this way, the increased diversity improves the defenses of LLMs, which conserves processing resources that would otherwise be wasted by handling breaches.

In one or more embodiments, operations comprise applying a similarity filter to remove prompt samples from the plurality of prompt samples that are redundant; and applying a pruning phase to remove prompt samples from the plurality of prompt samples that are not relevant to achieving the red-teaming goal. In this way, the system conserves computing resources, networking resources, and/or other resources that would have otherwise been consumed by processing redundant or irrelevant prompt samples.

In one or more embodiments, the similarity filter uses a cosine similarity metric to remove the prompt samples that are redundant. In this way, the system is easily scalable, which conserves processing resources and time.

In one or more embodiments, the operations comprise selecting the plurality of jailbreak prompt samples based on a ranking of prompt samples according to a potential for jailbreak success.

According to an aspect, a computer program product includes one or more computer-readable storage media and program instructions stored on the one or more computer-readable storage media to perform operations. The operations comprise selecting a subset of clusters from an attack style library based on a red-teaming goal associated with bypassing measures that are to prevent non-aligned outputs of LLMs. The operations comprise generating, using a strategy diversification LLM, a diverse set of seed prompts by combining attack styles from the selected subset of clusters. The operations comprise branching each seed prompt of the diverse set of seed prompts into a plurality of prompt samples using a branching LLM. The operations comprise applying a similarity filter to remove redundant prompt samples. The operations comprise evaluating the diverse set of jailbreak prompt samples against a target LLM to determine jailbreak success potential. The operations comprise outputting a set of selected jailbreak prompt samples that are selected based on the evaluating.

By generating diverse multi-style jailbreak samples in a resource and query efficient manner, the operations conserve computing resources, networking resources, and/or other resources that would have otherwise been consumed by processing redundant or irrelevant prompt samples. Additionally, the operations may reduce memory requirements by storing fewer, more effective jailbreak samples. In this way, the operations may conserve processing resources, memory resources, network resources, and/or the like. The increased diversity improves the defenses of LLMs, which conserves processing resources that would otherwise be wasted by handling breaches.

In one or more embodiments, the diverse set of seed prompts is based on a merge of seed prompts from different branches. In this way, the increased diversity improves the defenses of LLMs, which conserves processing resources that would otherwise be wasted by handling breaches.

In one or more embodiments, the attack style library is modular and enables addition of newly discovered attack styles. In this way, the system is easily scalable, which conserves processing resources and time.

In one or more embodiments, the strategy diversification LLM combines attack styles from multiple clusters to generate a diverse set of seed jailbreak samples. The increased diversity improves the defenses of LLMs, which conserves processing resources that would otherwise be wasted by handling breaches.

In one or more embodiments, the operations comprise evaluating a relevance of each prompt sample to the red-teaming goal; and pruning prompt samples that do not meet a relevance threshold. In this way, the increased diversity improves the defenses of LLMs, which conserves processing resources that would otherwise be wasted by handling breaches.

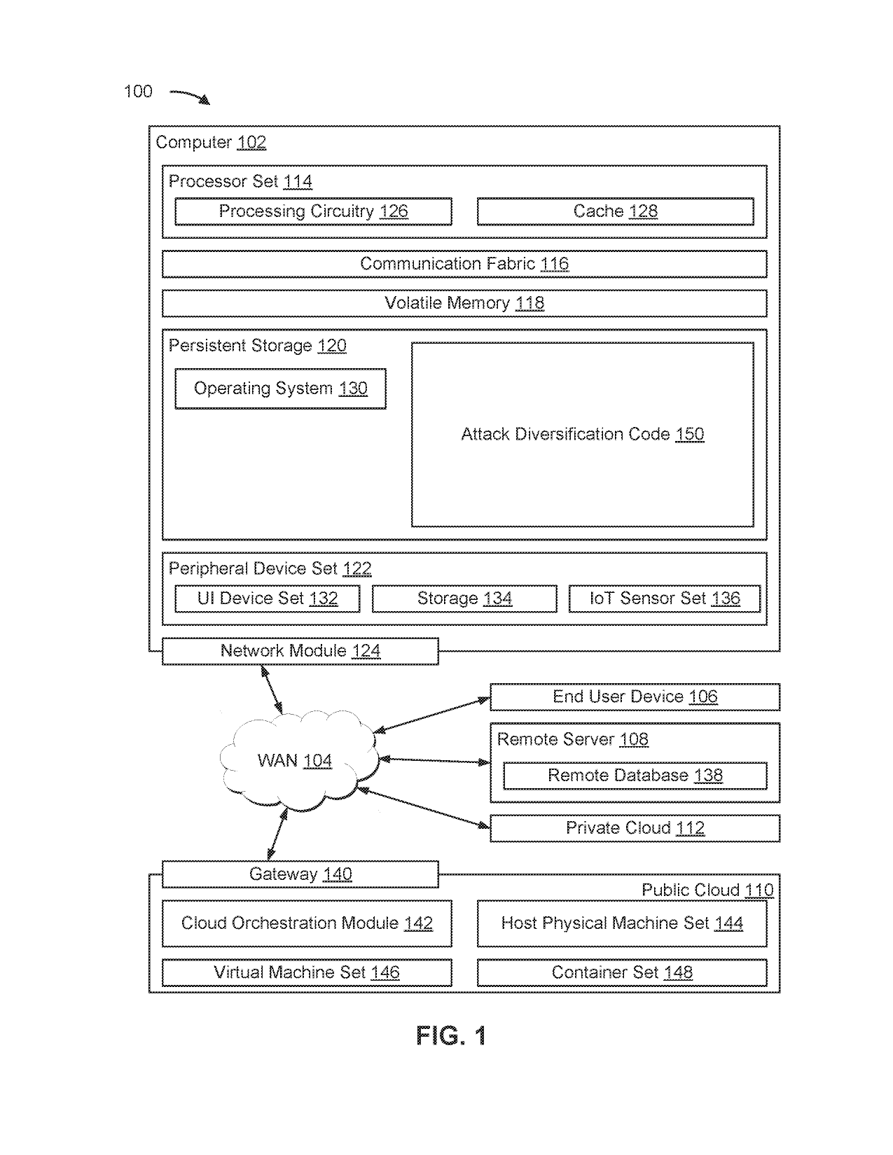

FIG. 1 is a diagram of an example computing environment 100 for automated red-teaming described herein.

Computing environment 100 contains an example of an environment for the execution of at least some of the computer code involved in performing the inventive methods, such as attack diversification code 150. In addition to attack diversification code 150, computing environment 100 includes, for example, computer 102, wide area network (WAN) 104, end user device (EUD) 106, remote server 108, public cloud 110, and private cloud 112. In this embodiment, computer 102 includes processor set 114 (including processing circuitry 126 and cache 128), communication fabric 116, volatile memory 118, persistent storage 120 (including operating system 130 and attack diversification code 150, as identified above), peripheral device set 122 (including user interface (UI) device set 132, storage 134, and Internet of Things (IoT) sensor set 136), and network module 124. Remote server 108 includes remote database 138. Public cloud 110 includes gateway 140, cloud orchestration module 142, host physical machine set 144, virtual machine set 146, and container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one, or more, computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in attack diversification code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

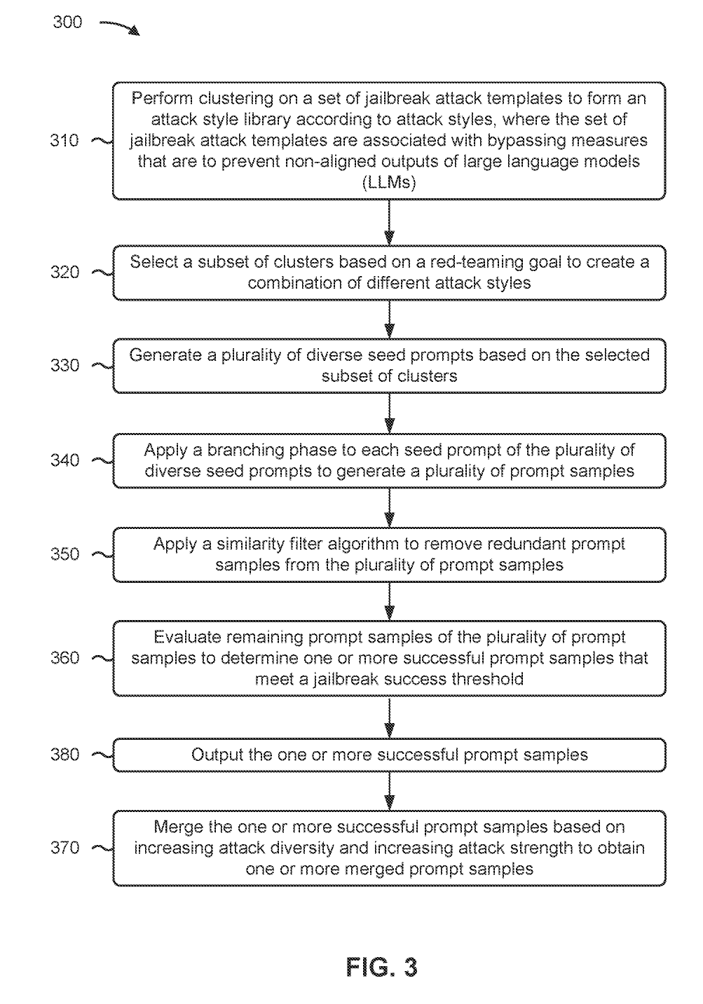

The code included in the attack diversification code 150 typically includes at least some of the computer code involved in performing one or more operations described herein, such as the operations of process 300 in FIG. 3 and the processes described in FIGS. 3-5

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and/or edge servers.

End user device (EUD) 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of virtualized computing environments (VCEs) will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In the context of language models, an LLM may produce aligned output. An aligned output for a LLM refers to a response that is consistent with the intended behavior, policies, and values of the model. In other words, an aligned output is one that is safe, accurate, informative, and non-harmful. Safe output may include output that does not contain any toxic, biased, or hate speech that can harm individuals or communities. Accurate output may include output that is accurate and free from factual errors, including inaccuracies in terms of numbers, dates, and other verifiable information. Aligned output may be relevant to the input prompt and context, and provide information that is useful and applicable to the conversation or task. Aligned output may also show respect for the user, including their identity, culture, and values, and does not perpetuate stereotypes or discriminatory language.

Unsafe or non-aligned outputs refer to responses that are not consistent with the desired behavior or policies of the model. These outputs can be problematic because they may contain information or language that is harmful (e.g., promoting hate speech, violence, or discriminatory behavior against individuals or groups, inaccurate, or biased. Non-aligned outputs can arise from various reasons, including adversarial attacks (e.g., malicious inputs designed to cause the model to produce specific, undesired outputs). The risks associated with non-aligned outputs include damage to reputation, real-world harm, and misuse by malicious actors.

To mitigate these risks, researchers and developers employ various strategies, such as data curation, stress-testing the model against various types of inputs and attacks, implementing checks to detect and prevent non-aligned outputs, or having human reviewers evaluate and correct the model's outputs. However, these approaches have been insufficient with respect to jailbreaking, which involves crafting specific inputs or prompts that are designed to manipulate the model's behavior, such as causing it to produce biased or toxic responses. Existing CRT checks are expensive, requiring constant updating of jailbreaking strategies and iterative runs through a vast number of goals. These methods often fail to incorporate newly discovered attack styles and may not be adaptable to specific model versions. Current approaches to mitigate these issues, such as using known attack libraries or static collections of jailbreak prompts, are limited in their ability to consider adaptations of these attacks to specific model versions and combinations of attack styles.

Some implementations described herein provide a computer system and method for scalable automated LLM red-teaming, which evaluates the robustness of LLMs against jailbreak attacks in a resource and query efficient manner, by generating diverse multi-style jailbreak samples. For example, the computer system may include clustering a set of jailbreak attack templates according to attack styles and then selecting a subset of clusters based on a red-teaming goal. The computer system may generate a diverse set of seed prompts based on the selected subset of clusters, and then apply a branching phase to each seed prompt to generate a plurality of prompt samples. The computer system may apply a similarity filter algorithm to remove redundant prompt samples, and evaluate remaining prompt samples to determine one or more successful prompt samples that meet a jailbreak success threshold. The system may output the successful prompt samples. In some aspects, the computer system may further merge the one or more successful prompt samples based on increasing attack diversity and increasing attack strength to obtain one or more merged prompt samples.

In some aspects, the computer system may involve multiple operations. The computer system may receive a set of jailbreak attack templates and clusters them into a plurality of clusters according to attack styles. The clustering allows for the identification of different attack styles and strategies. The computer system may select a subset of clusters from the plurality of clusters based on a red-teaming goal. The selection allows for the identification of the most relevant attack styles and strategies for the given goal. The computer system may generate a diverse set of seed prompts based on the selected subset of clusters. The generation involves the use of a strategy diversification LLM to combine attack styles from multiple clusters. The computer system may apply a branching phase to each seed prompt of the diverse set of seed prompts to generate multiple prompt samples. The branching step allows for the generation of multiple prompt samples from a single seed prompt.

Other operations may include the computer system applying a similarity filter algorithm to remove redundant prompt samples from the plurality of prompt samples. The filtering ensures that the prompt samples are diverse and not redundant. The computer system may evaluate the remaining prompt samples against a target LLM to determine jailbreak success potential. The evaluation may involve the use of a scoring function to assign a score (e.g., numerical value, percentage) to each prompt sample based on its potential for jailbreak success. The computer system may select a plurality of jailbreak prompt samples from the plurality of prompt samples for each seed prompt based on the evaluation scores. The selection step allows for the identification of the most effective prompt samples for jailbreaking. The computer system may merge the selected prompt samples to create a diverse set of jailbreak prompt samples that are diverse with respect to attack style. The merging may involve the use of a multi-style merging process to combine prompt samples from different branches.

The computer system may involve the use of various LLMs that are part of the red-teaming attacks. The LLMs may include a clustering LLM that is trained to cluster the jailbreak attack templates into clusters according to attack styles. A strategy diversification LLM may select clusters, combine attack styles from multiple clusters, and generate a diverse set of seed prompts. A branching LLM may be trained to branch the seed prompts into multiple prompt samples. An evaluation LLM may be used to evaluate the prompt samples and assign a score to each prompt sample based on its potential for jailbreak success.

The computer system may further red-teaming goals with a solution that can be scaled up to handle large amounts of data and complex models, while being resource and query-efficient, reducing the computational costs associated with traditional red teaming methods. The solution generates diverse multi-style jailbreak samples, allowing for a more comprehensive evaluation of the LLM's robustness. The solution can be adapted to different LLMs and red-teaming goals, making it a versatile tool for evaluating the robustness of LLMs.

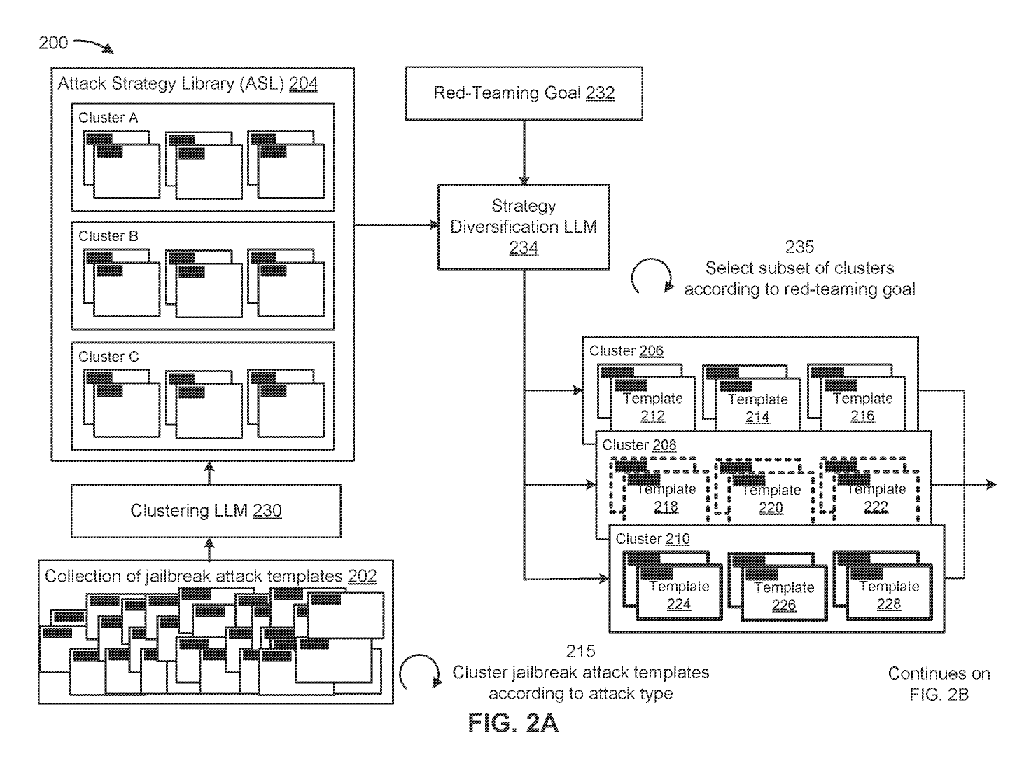

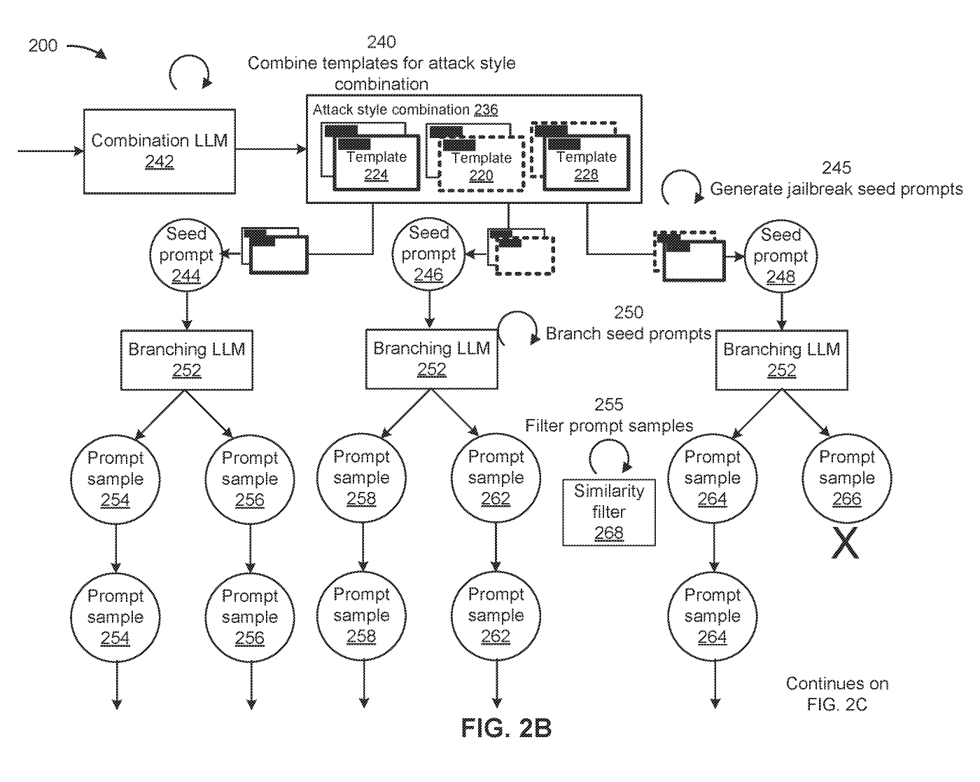

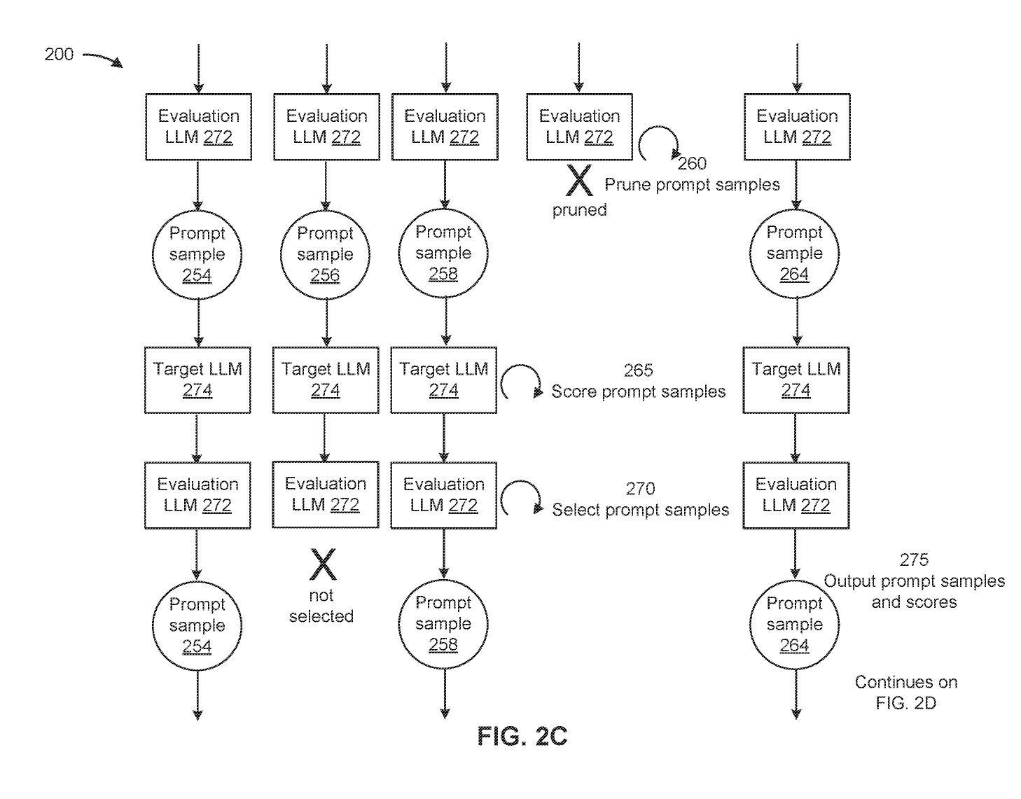

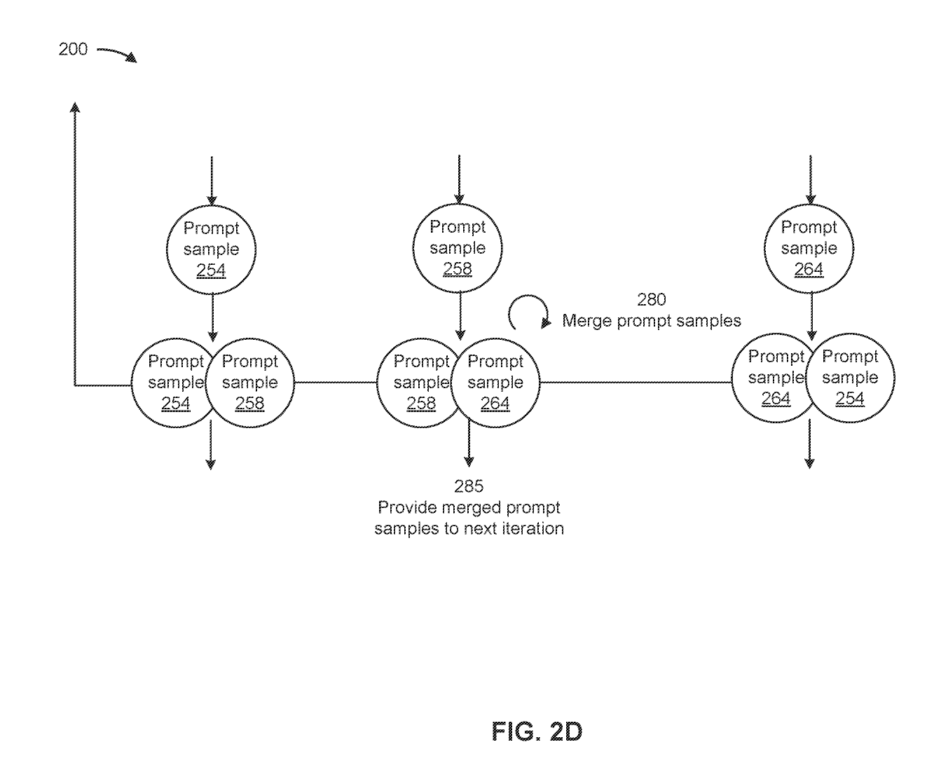

FIGS. 2A-2D shows a diagram 200 of an architecture for an attack diversification system that is designed to meet a red-teaming goal. The architecture may be performed by a system (e.g., computer 102, computer system involving one or more computers) that generates diverse jailbreak prompts to test the security of target language models.

As shown in diagram 200 of FIG. 2A, the system may use an attack strategy library (ASL) 204 that includes clusters of jailbreak attack templates (e.g., sets of prompt samples for attacking or jailbreaking an LLM) that are obtained from a collection of jailbreak attack templates 202 and clustered by a clustering LLM 230, as shown by reference number 215. The clustering LLM 230 may cluster the jailbreak attack templates into a plurality of clusters according to attack type. Cluster A is a first attack type, cluster B is a second attack type, cluster C is a third attack type, and so forth.

In some aspects, the system may select a subset of clusters (206, 208, and 210) based on a red-teaming goal 232, as shown by reference number 235. Examples of red-teaming goals may include, in a safe and authorized context, using attacks to show vulnerabilities related to bypassing a language model's content moderation mechanisms, exfiltrating sensitive information (e.g., personally identifiable information or financial data, from a language model's training data), disrupting user interactions with a language model (causing the model to produce unhelpful or confusing responses), manipulating model behavior (causing the model to produce biased or inaccurate responses), extracting intellectual property, disrupting the business operations of an organization that relies on language models, or compromising user safety.

The system may use a strategy diversification LLM 234 to select clusters and combine the jailbreak attack templates of the clusters, where each cluster represents a different attack style. The strategy diversification LLM may operate to diversify and spread out how the jailbreak attack templates are clustered and to divide the clusters into multiple attack styles.

Diagram 200 shows cluster 206 (with at least jailbreak templates 212, 214, and 216) for a first attack style, cluster 208 (with at least jailbreak templates 218, 220, and 222) for a second attack style, and cluster 210 (with at least jailbreak templates 224, 226, and 228) for a third attack style. The computer system may then generate a plurality of diverse seed prompts based on the selected subset of clusters for example, using a seed prompt LLM.

In some aspects, inputs to the system may include a quantity N of clusters for clustering attack templates in attack style library, a quantity C of selected clusters for style combinations with given goal in strategy diversification, a quantity S of styles to combine from C clusters in strategy diversification, a quantity B of branches for seed jailbreaking samples, and a branching factor F denoting the quantity of generated samples in each branch. Other system inputs may include a pruning factor P denoting a maximum quantity of retained samples after pruning phase II, a maximum quantity of iterations M for controlling the quantity of times the method will loop to generate jailbreak samples for a given goal, a threshold T for similarity of prompts, and a quantity of branches L to merge in multi-style merging. The system may output a set of jailbreak prompts with high potential for successful jailbreak according to intended red-teaming goal.

FIG. 2B is a continuation of the architecture for a system that generates diverse jailbreak prompts to test the security of target language models.

As shown by reference number 240, the system may use a combination LLM 242 to combine the attack styles from a selected subset of clusters 206, 208, and 210 to create a combination of different attack styles. The combination LLM 242 may use a strategy diversification process to generate a diverse set of attack strategies. For example, the combination LLM 242 may use a set of rules or algorithms to determine which attack styles to combine and how to combine them. This may involve selecting the first attack style from cluster 206, selecting the second attack style from cluster 208, and then combining the two attack styles to create a new attack strategy, shown in style attack combination 236, which includes templates 224 and 228 from cluster 210 and template 220 from cluster 208.

The combination LLM 242 may also use a set of predefined rules to determine which attack styles are most likely to result in a successful attack. For example, the combination LLM 242 may use a rule that specifies that if the target language model is a transformer-based model, then combine attack styles A and B to create a new attack strategy.

As shown by reference number 245, the system may generate jailbreak seed prompts. A seed prompt may be an initial prompt or input that is used to generate a series of subsequent prompts or inputs, known as prompt samples, through a process called branching. In the context of LLMs, a seed prompt is typically a single input that is used to start the generation of a sequence of outputs. The seed prompt can be a word, phrase, or sentence that is designed to elicit a specific response or behavior from the language model. In the context of jailbreaking language models, a seed prompt may be used as a starting point for generating a series of prompt samples that are designed to test the model's robustness and security. The seed prompt may be crafted to exploit a specific vulnerability or weakness in the model, or to simulate a particular type of attack or threat. Seed prompts can be generated manually, using automated tools or algorithms (e.g., machine learning algorithms), or using prompt engineering. A seed prompt may vary in length, complexity, relevance, or creativity.

The combination LLM 242 may apply a strategy diversification process to generate a diverse set of seed prompts 244, 246, 248 based on the attack styles from the selected clusters. This process combines the attack strategies from multiple clusters to create a diverse set of seed prompts. For example, if the red-teaming goal 232 is to bypass content moderation, the combination LLM 242 may select clusters containing attack styles related to hate speech, personal attacks, and misinformation. The combination LLM 242 may combine these attack styles to generate seed prompts that are likely to bypass content moderation mechanisms. The seed prompts are then used as input to a branching LLM 252, which generates a plurality of prompt samples by iteratively applying small changes to the seed prompts.

As shown by reference number 250, the system may branch (e.g., split and diversify) the seed prompts. The system may use a branching LLM 252 to branch the seed prompts into a plurality of prompt samples. This branching LLM 252 helps to increase the diversification of the attack strategies. For example, the branching LLM 252 may use a set of rules or algorithms to determine which seed prompts to branch and how to branch them. This may involve selecting a first seed prompt 244, selecting a second seed prompt, and branching the two seed prompts to create new prompt samples 254 and 256 (e.g. similar but not the same). Seed prompt 246 may be branched into prompt samples 258 and 262. Seed prompt 248 may be branched into prompt samples 264 and 266.

Branching the seed prompt into multiple prompt samples helps to increase the number and diversity of prompt samples to better identify potential vulnerabilities and weaknesses in a model. Branching enables the exploration of different parts of the model's input space, which can help to identify potential blind spots and areas where the model may be vulnerable to attack. Branching allows for the combination of different attack styles and strategies, which can lead to the creation of more complex and creative attacks that may be able to bypass the model's defenses. Branching can help to identify potential weaknesses in the model by generating a large number of prompt samples that can be used to test the model's robustness and security. Branching can help reduce the number of false positives, as the branching process can help to filter out irrelevant or incomplete prompts. Branching can improve the efficiency of testing by generating a large number of prompts in a single step, reducing the need for manual testing and evaluation. Branching can help to explore different attack paths and identify potential vulnerabilities that may not have been previously identified.

As shown by reference number 255, the system may filter prompt samples. For example, the system may use a similarity filter 268 to remove redundant prompt samples, such as prompt sample 266. The similarity filter 268 is used to ensure that the prompt samples are diverse and do not contain redundant information. In the context of jailbreaking language models, the similarity filter is used to identify and remove prompt samples that are too similar to each other. The similarity filter 268 may operate by comparing the linguistic features of different prompt samples. This can include features such as token-level similarity that compares the similarity between individual words or tokens in the prompt samples, sentence-level similarity that compares the similarity between sentences or phrases in the prompt samples, or semantic similarity that compares the similarity between the meanings or semantics of the prompt samples.

The similarity filter 268 may use a combination of natural language processing (NLP) and machine learning algorithms to compare the similarity between prompt samples. Some common algorithms used for similarity filtering include cosine similarity (measure of similarity between two vectors that calculates the cosine of the angle between the two vectors), Jaccard similarity (measure of similarity between two sets that calculates the size of their intersection divided by the size of their union), or word embeddings (representation of words as dense vectors that capture their semantic meaning).

FIG. 2C is a continuation of the architecture for a system that generates diverse jailbreak prompts to test the security of target language models.

In addition, the system includes a pruning phase that is used to prune the prompt samples based on their relevance to the red-teaming goal. This pruning phase is used to ensure that the prompt samples are relevant to the target language model and are likely to result in a successful attack. As shown by reference number 260, the system may prune prompt sample 262. The system may use a target LLM 274 and an evaluation LLM 272 to evaluate the prompt samples generated by the branching LLM 252. The target LLM 274 may determine the potential for jailbreak success of each prompt sample. For example, the evaluation LLM 272 may use a set of rules or algorithms to determine which prompt samples are most likely to result in a successful attack. This may involve evaluating the prompt samples based on their similarity to known jailbreak attacks, their relevance to the target LLM 274, and their potential to bypass the model's security measures. The target LLM 274 may be the LLM that is being tested by the simulated attacks using the remaining prompt samples.

As shown by reference number 265, the evaluation LLM 272 may assign a score (using a scoring function) to each prompt sample based on its potential for jailbreak success. The score may be based on a number of factors, including the prompt sample's similarity to known jailbreak attacks, its relevance to the target language model, and its potential to bypass the model's security measures. As shown by reference number 270, the system may select prompt samples based on the scores. The system may use evaluation LLM 272 to evaluate and select sample prompts based on the scores. For example, sample prompts with scores above a threshold may be selected. The system may select the top-ranked prompt samples after using a ranking algorithm to rank the prompt samples based on their scores. In diagram 200, the system does not select prompt sample 256. As shown by reference number 275, the system may output prompt samples with corresponding scores. The output process may use a set of rules or algorithms to determine which prompt samples to output and how to output the prompt samples.

FIG. 2D is a continuation of the architecture for a system that generates diverse jailbreak prompts to test the security of target language models.

As shown by reference number 280, the system may merge the selected prompt samples to create a diverse set of jailbreak prompts that are diverse with respect to attack style. This merging process may use a set of rules or algorithms to determine which prompt samples to merge and how to merge them. This may involve combining the attack styles (multi-style merge) of multiple prompt samples to create a new prompt sample that is more likely to result in a successful attack.

The merging process may use a set of machine learning algorithms to determine which prompt samples to merge and how to merge them. For example, the system may use a clustering algorithm to group the prompt samples based on their attack styles, and then merge the prompt samples within each cluster to create new prompt samples.

As shown by reference number 285, the system may provide the merged prompt samples to a next iteration of the evaluation by the evaluation LLM 272. The merged prompt samples may be used against the target LLM 274 and evaluated, as part of a next cycle of the process.

In some aspects, the system may use a feedback loop to refine the merging process based on the results of the output process. The feedback loop may use a set of rules or algorithms to determine which prompt samples were most effective in resulting in a successful attack, and to refine the merging process to generate more effective prompt samples. In addition, the system may use a continuous learning process to continually update and refine the merging process based on new data and feedback. The continuous learning process may use a set of machine learning algorithms to learn from the results of the output process and to refine the merging process to generate more effective prompt samples.

In sum, the modular ASL 204 with automatic cluster assignment of attack styles may combine a two-step selection process to overcome a large action space challenge (a large number of templates that contain long text descriptions). The modular nature of the system allows easy extension to include newly discovered attack styles. Multi-style merging to create diverse and novel style combinations greatly increases the attack success rate (ASR) and attack diversity.

FIG. 3 is a flowchart of an example process 300 associated with LLM red-teaming. One or more process blocks of FIG. 3 are performed by a processor set (e.g., processor set 114) and/or by another device or a group of devices separate from or including the processor set 114.

As shown in FIG. 3, process 300 includes cluster (performing clustering on) a set of jailbreak attack templates to form an attack style library according to attack styles, where the set of jailbreak attack templates are associated with bypassing measures that are to prevent non-aligned outputs of LLMs (block 310). For example, the processor set may perform clustering on a set of jailbreak attack templates to form an attack style library according to attack styles, where the set of jailbreak attack templates are associated with bypassing measures that are to prevent non-aligned outputs of LLMs, as described above.

As further shown in FIG. 3, process 300 includes selecting a subset of clusters based on a red-teaming goal to create a combination of different attack styles (block 320). For example, the processor set may select a subset of clusters based on a red-teaming goal to create a combination of different attack styles, as described above.

As further shown in FIG. 3, process 300 includes generating a plurality of diverse seed prompts based on the selected subset of clusters (block 330). For example, the processor set may generate a plurality of diverse seed prompts based on the selected subset of clusters, as described above.

As further shown in FIG. 3, process 300 includes applying a branching phase to each seed prompt of the plurality of diverse seed prompts to generate a plurality of prompt samples (block 340). For example, the processor set may apply a branching phase to each seed prompt of the plurality of diverse seed prompts to generate a plurality of prompt samples, as described above.

As further shown in FIG. 3, process 300 includes applying a similarity filter algorithm to remove redundant prompt samples from the plurality of prompt samples (block 350). For example, the processor set may apply a similarity filter algorithm to remove redundant prompt samples from the plurality of prompt samples, as described above.

As further shown in FIG. 3, process 300 includes evaluating remaining prompt samples of the plurality of prompt samples to determine one or more successful prompt samples that meet a jailbreak success threshold (block 360). For example, the processor set may evaluate remaining prompt samples of the plurality of prompt samples to determine one or more successful prompt samples that meet a jailbreak success threshold, as described above.

As further shown in FIG. 3, process 300 includes outputting the one or more successful prompt samples (block 370). For example, the processor set may output the one or more successful prompt samples, as described above.

As further shown in FIG. 3, process 300 includes merging the one or more successful prompt samples based on increasing attack diversity and increasing attack strength to obtain one or more merged prompt samples (block 380). For example, the processor set may merge the one or more successful prompt samples based on increasing attack diversity and increasing attack strength to obtain one or more merged prompt samples, as described above.

Process 300 may include additional aspects, such as any single aspect or any combination of aspects described below and/or in connection with one or more other processes described elsewhere herein.

In a first aspect, process 300 includes applying a pruning phase to remove prompt samples from the plurality of prompt samples that are not relevant to achieving the red-teaming goal.

In a second aspect, alone or in combination with the first aspect, process 300 includes merging, by the processor set, the one or more successful prompt samples based on increasing attack diversity and increasing attack strength to obtain one or more merged prompt samples, and providing the one or more merged prompt samples to a next iteration of the evaluating.

In a third aspect, alone or in combination with one or more of the first and second aspects, the clustering of the set of jailbreak attack templates comprises clustering the set of jailbreak attack templates using a clustering LLM.

In a fourth aspect, alone or in combination with one or more of the first through third aspects, the evaluating of the remaining prompt samples comprises evaluating the remaining prompt samples using an evaluation LLM.

In a fifth aspect, alone or in combination with one or more of the first through fourth aspects, the attack style library is a modular library.

In a sixth aspect, alone or in combination with one or more of the first through fifth aspects, the generating of the plurality of diverse seed prompts comprises generating the plurality of diverse seed prompts using a seed prompt LLM.

In a seventh aspect, alone or in combination with one or more of the first through sixth aspects, the combination of different attack styles includes an attack based on persuasion, an attack based on encoded data, an attack based on a logical fallacy, or a combination thereof.

In an eighth aspect, alone or in combination with one or more of the first through seventh aspects, the merging comprises combining prompt samples from different branches.

Although FIG. 3 shows example blocks of process 300, in some implementations, process 300 includes additional blocks, fewer blocks, different blocks, or differently arranged blocks than those depicted in FIG. 3. Additionally, or alternatively, two or more of the blocks of process 300 may be performed in parallel.

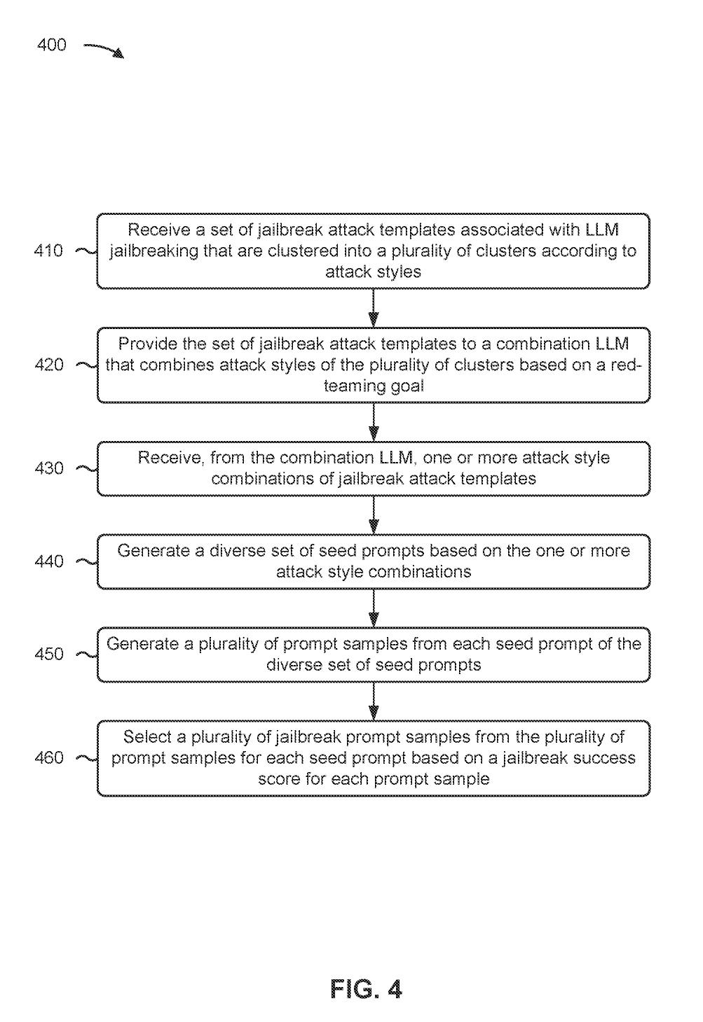

FIG. 4 is a flowchart of an example process 400 associated with LLM red-teaming. One or more process blocks of FIG. 4 are performed by a computer system (e.g., one or more computers 102) and/or by another device or a group of devices separate from or including the computer system.

As shown in FIG. 4, process 400 includes receiving a set of jailbreak attack templates associated with LLM jailbreaking that are clustered into a plurality of clusters according to attack styles (block 410). For example, the computer system may receive a set of jailbreak attack templates associated with LLM jailbreaking that are clustered into a plurality of clusters according to attack styles, as described above.

As further shown in FIG. 4, process 400 includes providing the set of jailbreak attack templates to a combination LLM that combines attack styles of the plurality of clusters based on a red-teaming goal (block 420). For example, the computer system may provide the set of jailbreak attack templates to a combination LLM that combines attack styles of the plurality of clusters based on a red-teaming goal, as described above.

As further shown in FIG. 4, process 400 includes receiving, from the combination LLM, one or more attack style combinations of jailbreak attack templates (block 430). For example, the computer system may receive, from the combination LLM, one or more attack style combinations of jailbreak attack templates, as described above.

As further shown in FIG. 4, process 400 includes generating a diverse set of seed prompts based on the one or more attack style combinations (block 440). For example, the computer system may generate a diverse set of seed prompts based on the one or more attack style combinations, as described above.

As further shown in FIG. 4, process 400 includes generating a plurality of prompt samples from each seed prompt of the diverse set of seed prompts (block 450). For example, the computer system may generate a plurality of prompt samples from each seed prompt of the diverse set of seed prompts, as described above.

As further shown in FIG. 4, process 400 includes selecting a plurality of jailbreak prompt samples from the plurality of prompt samples for each seed prompt based on a jailbreak success score for each prompt sample (block 460). For example, the computer system may select a plurality of jailbreak prompt samples from the plurality of prompt samples for each seed prompt based on a jailbreak success score for each prompt sample, as described above.

Process 400 may include additional aspects, such as any single aspect or any combination of aspects described below and/or in connection with one or more other processes described elsewhere herein.

In a first aspect, the operations comprise outputting the plurality of jailbreak prompt samples.

In a second aspect, alone or in combination with the first aspect, the operations comprise applying a branching phase to multiply the plurality of prompt samples.

In a third aspect, alone or in combination with one or more of the first and second aspects, the operations comprise applying a similarity filter to remove prompt samples from the plurality of prompt samples that are redundant, and applying a pruning phase to remove prompt samples from the plurality of prompt samples that are not relevant to achieving the red-teaming goal.

In a fourth aspect, alone or in combination with one or more of the first through third aspects, the similarity filter uses a cosine similarity metric to remove the prompt samples that are redundant.

In a fifth aspect, alone or in combination with one or more of the first through fourth aspects, the operations comprise selecting the plurality of jailbreak prompt samples based on a ranking of prompt samples according to a potential for jailbreak success.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

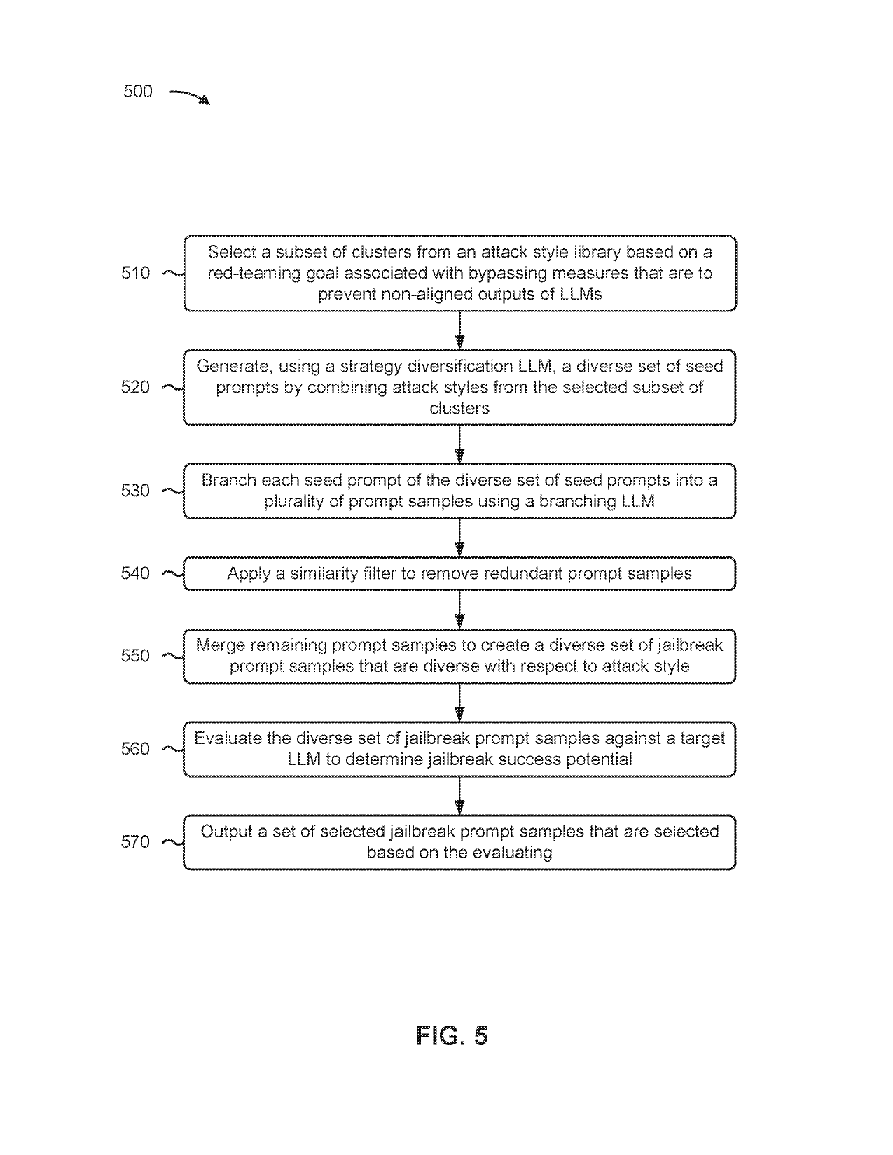

FIG. 5 is a flowchart of an example process 500 associated with LLM red-teaming. One or more process blocks of FIG. 5 are performed by a device (e.g., computer 102) and/or by another device or a group of devices separate from or including the device.

As shown in FIG. 5, process 500 includes selecting a subset of clusters from an attack style library based on a red-teaming goal associated with bypassing measures that are to prevent non-aligned outputs of LLMs (block 510). For example, the device may select a subset of clusters from an attack style library based on a red-teaming goal associated with bypassing measures that are to prevent non-aligned outputs of LLMs, as described above.

As shown in FIG. 5, process 500 includes generating, using a strategy diversification LLM, a diverse set of seed prompts by combining attack styles from the selected subset of clusters (block 520). For example, the device may generate, using a strategy diversification LLM, a diverse set of seed prompts by combining attack styles from the selected subset of clusters, as described above.

As shown in FIG. 5, process 500 includes branching each seed prompt of the diverse set of seed prompts into a plurality of prompt samples using a branching LLM (block 530). For example, the device may branch each seed prompt of the diverse set of seed prompts into a plurality of prompt samples using a branching LLM, as described above.

As shown in FIG. 5, process 500 includes applying a similarity filter to remove redundant prompt samples (block 540). For example, the device may apply a similarity filter to remove redundant prompt samples, as described above.

As shown in FIG. 5, process 500 includes merging remaining prompt samples to create a diverse set of jailbreak prompt samples that are diverse with respect to attack style (block 550). For example, the device may merge remaining prompt samples to create a diverse set of jailbreak prompt samples that are diverse with respect to attack style, as described above.

As shown in FIG. 5, process 500 includes evaluating the diverse set of jailbreak prompt samples against a target LLM to determine jailbreak success potential (block 560). For example, the device may evaluate the diverse set of jailbreak prompt samples against a target LLM to determine jailbreak success potential, as described above.

As shown in FIG. 5, process 500 includes outputting a set of selected jailbreak prompt samples that are selected based on the evaluating (block 570). For example, the device may output a set of selected jailbreak prompt samples that are selected based on the evaluating, as described above.

Process 500 may include additional aspects, such as any single aspect or any combination of aspects described below and/or in connection with one or more other processes described elsewhere herein.

In a first aspect, the diverse set of seed prompts is based on a merge of seed prompts from different branches.

In a second aspect, alone or in combination with the first aspect, the attack style library is modular and enables addition of newly discovered attack styles.

In a third aspect, alone or in combination with one or more of the first and second aspects, the strategy diversification LLM combines attack styles from multiple clusters to generate a diverse set of seed jailbreak samples.

In a fourth aspect, alone or in combination with one or more of the first through third aspects, the operations comprise evaluating a relevance of each prompt sample to the red-teaming goal, and pruning prompt samples that do not meet a relevance threshold.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method, comprising:
clustering, by a processor set, a set of jailbreak attack templates to form an attack style library according to attack styles, wherein the set of jailbreak attack templates are associated with bypassing measures that are to prevent non-aligned outputs of large language models (LLMs);
selecting, by the processor set, a subset of clusters based on a red-teaming goal to create a combination of different attack styles;
generating, by the processor set, a plurality of diverse seed prompts based on the selected subset of clusters;
applying, by the processor set, a branching phase to each seed prompt of the plurality of diverse seed prompts to generate a plurality of prompt samples;
applying, by the processor set, a similarity filter algorithm to remove redundant prompt samples from the plurality of prompt samples;
evaluating, by the processor set, remaining prompt samples of the plurality of prompt samples to determine one or more successful prompt samples that meet a jailbreak success threshold; and
outputting, by the processor set, the one or more successful prompt samples.

2. The computer-implemented method of claim 1, further comprising:
applying a pruning phase to remove prompt samples from the plurality of prompt samples that are not relevant to achieving the red-teaming goal.

3. The computer-implemented method of claim 1, further comprising:
merging the one or more successful prompt samples based on increasing attack diversity and increasing attack strength to obtain one or more merged prompt samples; and
providing the one or more merged prompt samples to a next iteration of the evaluating.

4. The computer-implemented method of claim 1, wherein the merging comprises combining prompt samples from different branches.

5. The computer-implemented method of claim 1, wherein the clustering of the set of jailbreak attack templates comprises clustering the set of jailbreak attack templates using a clustering LLM.

6. The computer-implemented method of claim 1, wherein the evaluating of the remaining prompt samples comprises evaluating the remaining prompt samples using an evaluation LLM.

7. The computer-implemented method of claim 1, wherein the attack style library is a modular library.

8. The computer-implemented method of claim 1, wherein the generating of the plurality of diverse seed prompts comprises generating the plurality of diverse seed prompts using a seed prompt LLM.

9. The computer-implemented method of claim 1, wherein the combination of different attack styles includes an attack based on persuasion, an attack based on encoded data, an attack based on a logical fallacy, or a combination thereof.

10. A computer system, comprising:
a processor set;
one or more computer-readable storage media; and
program instructions stored on the one or more computer-readable storage media to cause the processor set to perform operations comprising:
receiving a set of jailbreak attack templates associated with large language model (LLM) jailbreaking that are clustered into a plurality of clusters according to attack styles;
providing the set of jailbreak attack templates to a combination LLM that combines attack styles of the plurality of clusters based on a red-teaming goal;
receiving, from the combination LLM, one or more attack style combinations of jailbreak attack templates;
generating a diverse set of seed prompts based on the one or more attack style combinations;
generating a plurality of prompt samples from each seed prompt of the diverse set of seed prompts; and
selecting a plurality of jailbreak prompt samples from the plurality of prompt samples for each seed prompt based on a jailbreak success score for each prompt sample.

11. The computer system of claim 10, wherein the operations comprise:
outputting the plurality of jailbreak prompt samples.

12. The computer system of claim 10, wherein the operations comprise:
applying a branching phase to multiply the plurality of prompt samples.

13. The computer system of claim 10, wherein the operations comprise:
applying a similarity filter to remove prompt samples from the plurality of prompt samples that are redundant; and
applying a pruning phase to remove prompt samples from the plurality of prompt samples that are not relevant to achieving the red-teaming goal.

14. The computer system of claim 13, wherein the similarity filter uses a cosine similarity metric to remove the prompt samples that are redundant.

15. The computer system of claim 10, wherein the operations comprise:
selecting the plurality of jailbreak prompt samples based on a ranking of prompt samples according to a potential for jailbreak success.

16. A computer program product, comprising:
one or more computer-readable storage media; and
program instructions stored on the one or more computer-readable storage media to perform operations comprising:
selecting a subset of clusters from an attack style library based on a red-teaming goal associated with bypassing measures that are to prevent non-aligned outputs of large language models (LLMs);
generating, using a strategy diversification LLM, a diverse set of seed prompts by combining attack styles from the selected subset of clusters;
branching each seed prompt of the diverse set of seed prompts into a plurality of prompt samples using a branching LLM;
applying a similarity filter to remove redundant prompt samples;
merging remaining prompt samples to create a diverse set of jailbreak prompt samples that are diverse with respect to attack style;
evaluating the diverse set of jailbreak prompt samples against a target LLM to determine jailbreak success potential; and
outputting a set of selected jailbreak prompt samples that are selected based on the evaluating.

17. The computer program product of claim 16, wherein the diverse set of seed prompts is based on a merge of seed prompts from different branches.

18. The computer program product of claim 16, wherein the attack style library is modular and enables addition of newly discovered attack styles.

19. The computer program product of claim 16, wherein the strategy diversification LLM combines attack styles from multiple clusters to generate a diverse set of seed jailbreak samples.

20. The computer program product of claim 16, wherein the operations comprise:
evaluating a relevance of each prompt sample to the red-teaming goal; and
pruning prompt samples that do not meet a relevance threshold.
